(19) United States
(12) Patent Application Publication
(10) Pub. No.: US 2011/0204138 A1
(43) Pub. Date: Aug. 25, 2011

(54) Bank account consolidated management system

(76) Inventor: Shuko Ukuda, Yokohama (JP)

(21) Appl. No.: 12/660,160

(22) Filed: Feb. 23, 2010

(51) Int. Cl. G06Q 40/00

(52) U.S. Cl. 235/379

(57) ABSTRACT

A bank account integration control system designed to operate so that the item names of a plurality of information that is included in second or new bank account information corresponding to bank accounts of a bank after a merger and a plurality of code that identifies the item names are made to correspond and stored, a plurality of information that is included in the first or old bank account information corresponding to customer bank accounts established at the first or old bank before the merger is made to correspond to each item name and stored, code that is made to correspond to the item names that are the same as the item names included in the first or old account information and stored is read out, coded account information that gives the read out code to each item name that is included in the first or old account information is created, and based on the corresponding code information and the coded account information, creates account information that corresponds the plurality of information included in the first or old account information with each item name included in the second or new account information, account information that matches the format of the new bank based on accounts opened at the old bank can be created by corresponding information included in the account information of the old bank with the code for each item name that is included in the account information for the new bank.

### BACKGROUND OF THE INVENTION

1. Field of the Invention

This invention relates to information technology for controlling account information corresponding to bank accounts established at banks.

2. Description of the Related Art

Customer information related to bank accounts established at banks, that is account information such as the customer's name, address, identification, the account balance, etc., is controlled by respective information control systems built by each individual bank, as seen for instance in Japanese Laid-open Patent Application No. 2008-134766. When two or more banks merge, there is a need to consolidate all of this account information controlled by these respective information control systems for each individual bank.

However, in these information systems built in several banks, there are cases where the information corresponding to the number of headings or items, the heading or item names, the form and format of the headings or items, etc., are different and it takes a great deal of effort and time to consolidate the account information from each bank. For example, if the bank account format is determined after the consolidation, a system is built where the input of account information corresponding to the format of the bank account after consolidation is carried out by installing a large number of office computer terminals and having a large number of operators display a window for entering the new account information at each computer terminal. Such a project for consolidating a system with a large number of bank accounts requires tens of thousands of man-hours and the costs for the large amount of effort, time, etc., become immense. Accordingly, there is a demand for a way to carry out such a integration of a large amount of account information that comes along with such a merger of banks at faster pace, with greater accuracy and efficiency and further at a lower cost.

### SUMMARY OF THE INVENTION

The present invention, in view of the above situation, provides a bank account integration control system which makes it possible to consolidate a large amount of account information that comes along with a merger of banks at faster pace, with greater accuracy and efficiency and further at a lower cost.

In order to solve the above problems, the present invention provides a bank account integration control system characterized in being provided with

a corresponding code information storage unit into which corresponding code information that corresponds to item names of a plurality of information that includes second account information (hereafter also new bank account information) corresponding to customer bank accounts established at a second bank (hereafter also new bank) which is the remaining bank after the merger of a first bank (hereafter also old bank) and another old bank and a plurality of code that identifies the item names are previously input and stored,

an old bank account information storage unit that stores a plurality of information that is made to correspond to each item name that is included in first bank account information (hereafter also old bank account information) corresponding to customer bank accounts established at the first bank (old bank),

an old bank account information recordal unit that receives the first or old bank account information and stores the received first or old bank account information in the old bank account information storage unit,

a coded account information generating unit that reads out code stored in the corresponding code information storage unit that is made to correspond to the item names that are the same as the item names included in the first account information and creates coded account information that is given to each item name that is included in the first account information, and

a new bank account information generating unit that, based on the corresponding code information and the coded account information, creates account information that corresponds the plurality of information included in the first account information with each item name included in the second account information.

As explained above, since the present invention is designed to operate so that the item names of a plurality of information that is included in second or new bank account information corresponding to bank accounts of a bank after a merger and a plurality of code that identifies the item names are made to correspond and stored, a plurality of information that is included in the first or old bank account information corresponding to customer bank accounts established at the first or old bank before the merger is made to correspond to each item name and stored, code that is made to correspond to the item names that are the same as the item names included in the first or old account information and stored is read out, coded account information that gives the read code to each item name that is included in the first or old account information is created, and based on the corresponding code information and the coded account information, creates account information that corresponds the plurality of information included in the first or old account information with each item name included in the second or new account information, account information that matches the format of the new bank based on accounts opened at the old bank can be created by corresponding information included in the account information of the old bank with the code for each item name that is included in the account information for the new bank. In this way, it becomes possible to consolidate a large amount of account information that comes along with a merger of banks at a faster pace, with greater accuracy and efficiency and further at a lower cost.

### BRIEF DESCRIPTION OF THE DRAWINGS

FIG. 1 is a general descriptive view of a construction example of the present bank account integration control system according to one embodiment of the present invention.

FIG. 2 is block diagram showing a construction example a device for controlling, converting and creating old bank account data according to one embodiment of the present invention.

FIG. 3 is a block diagram showing a construction example a device for consolidating and controlling new bank account data according to one embodiment of the present invention.

FIG. 4 is a diagram of an example of data for old bank account information according to one embodiment of the present invention.

FIG. 5 is a diagram of an example of data for corresponding code information according to one embodiment of the present invention.

FIG. 6 is a diagram of an example of data for coded bank account information according to one embodiment of the present invention.

FIG. 7 is a diagram of an example of data for the new bank input format according to one embodiment of the present invention.

FIG. 8 is a diagram of an example of data for old bank account information input in the new bank input format according to one embodiment of the present invention.

FIG. 9 is a diagram of an example of further data for old bank account information input in the new bank input format according to one embodiment of the present invention.

FIG. 10 is a diagram of an example of data for the new bank alternate input format according to one embodiment of the present invention.

FIG. 11 is a diagram of an input screen shown on a computer terminal according to one embodiment of the present invention.

FIG. 12 is a diagram of an example of a confirmation screen shown on a computer terminal according to one embodiment of the present invention.

FIG. 13 is a flow chart of the new bank account data conversion creation consolidating process according to one embodiment of the present invention.

FIG. 14 is a diagram of a system for consolidating and controlling new bank account data after a merger and establishing a bank account according to one embodiment of the present invention.

### DESCRIPTION OF THE PREFERRED EMBODIMENT

A preferred embodiment of the present invention will be described hereunder with reference to the drawings.

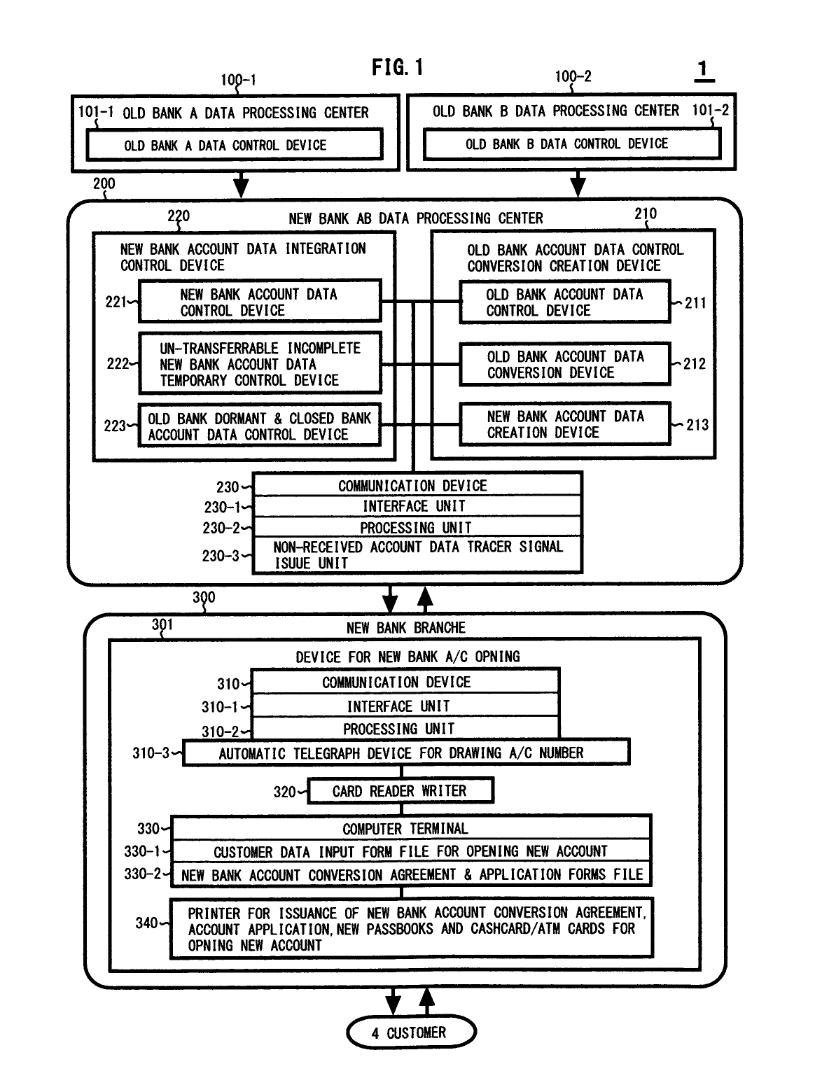

FIG. 1 is a block diagram of a construction of the present bank account integration control system 1 according to the present embodiment. The bank account integration control system 1 is provided with a variety of computer devices set up at an old bank data processing center 100-1 that processes data from a Bank A (Old Bank) that will merge with Bank B, an old bank data processing center 100-2 that processes data from Bank B that will merge with Bank A, a new bank data processing center 200 of the New Bank AB that is the result of the merger of Bank A and Bank B, a new bank branch 300 that is a branch of the new bank data processing center 200. Each of the computer devices are connected via a network.

In the old bank data processing center 100-1 are provided computers, such as an old bank data control device 101-1, that manage or control the account information of Bank A. Account information that includes customer information such as the name and balance of the bank accounts set up at Bank A, is input, stored and managed or controlled in the old bank data control device 101-1. In a similar fashion, in the old bank data processing center 100-2 are provided computers that manage the account information of Bank B, for example an old bank data control device 101-2. Account information that corresponds to the bank accounts set up at Bank B, is input, stored, and controlled in the old bank data processing device 101-2.

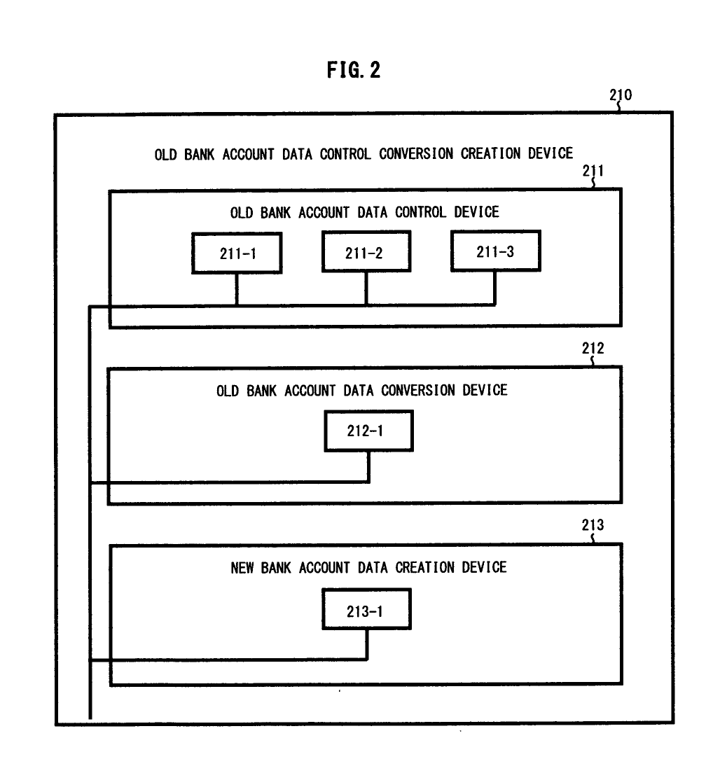

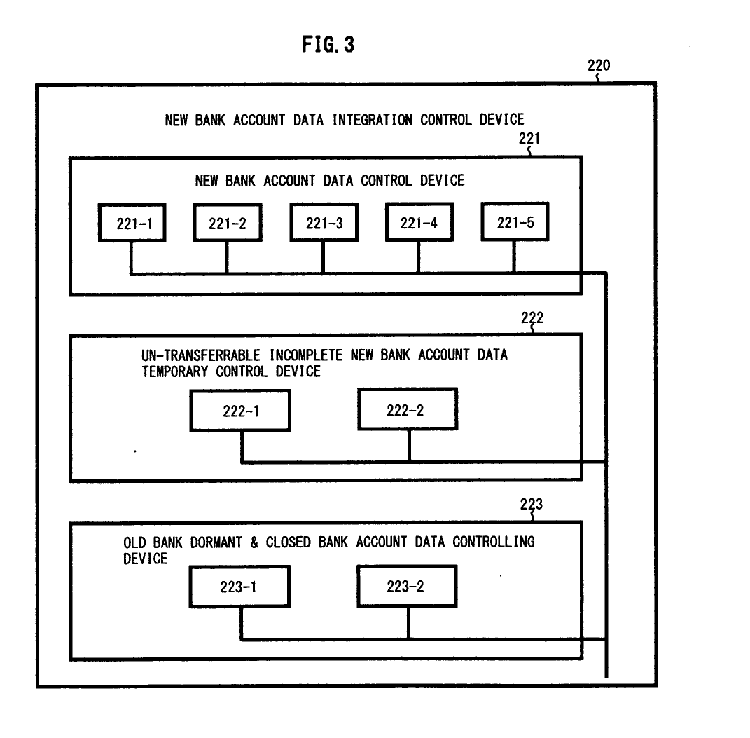

In the new bank data processing center 200 are provided an old bank account data control conversion creation device 210, new bank account data integration control device 220, and a communication device 230. The old bank account data control conversion creation device 210 is a computer device for creating new bank account information based on the old bank account information. FIG. 2 is a diagram showing the construction of the old bank account data control conversion creation device 210 in detail, and FIG. 3 is diagram showing the construction of the new bank account data integration control device 220 in detail. First, the construction of the old bank account data control conversion creation device 210 will be explained in reference to FIG. 2. The old bank account data control conversion creation device 210 is provided with an old bank account data control device 211, an old bank account data conversion device 212 and a new bank account data creation device 213.

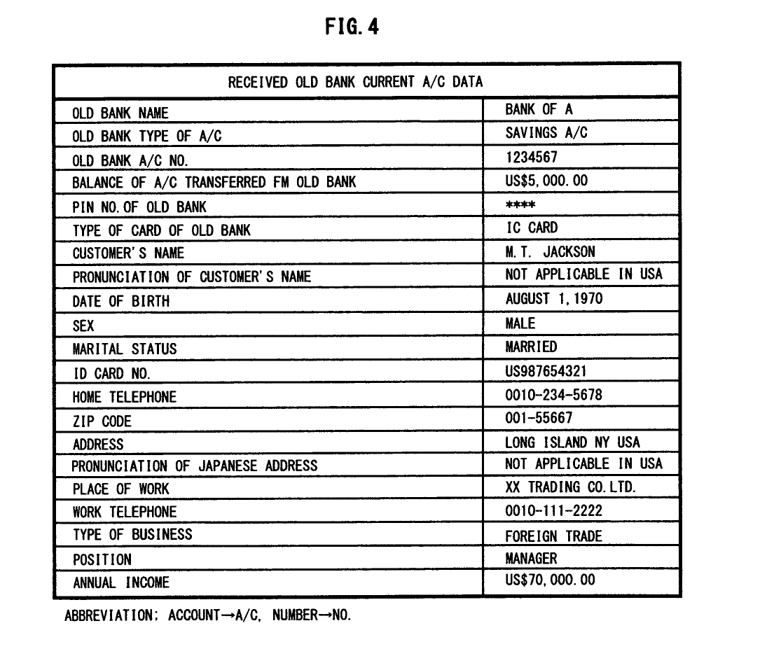

The old bank account data control device 211 is a computer device for inputting, storing and controlling old bank account information. In order to classify and achieve rational and efficient control of the variety of account data according to the present use status of the information of the accounts set up at the old bank, the old bank account data control device 211 is provided with three files such as old bank active account data file 211-1, old bank dormant account date file 211-2 and old bank closed or closed account data file 211-3, as internal devices. FIG. 4 is a diagram of an example of data for old bank account information that is input, stored and controlled in the old bank account data control device 211. A variety of information such as the old bank name, type of account, old bank account number, account balance (account balance at the time of data conversion), old account PIN, old bank account type, depositor's name, is included in the old bank account information.

Here, based on the present use status of the bank account information at the old bank, the account information is classified at the old bank account data control device 211 into active accounts, inactive or dormant accounts, closed accounts, etc., and the respective classified account information is input, stored and controlled in the files such as the old bank active account data file 211-1, old bank dormant account date file 211-2 and old bank closed account data file 211-3. Active accounts are accounts that have transactions such as deposits and withdrawals carried out on a regular basis. Dormant accounts are accounts do not have transactions such as deposits and withdrawals carried out for long periods of time greater than a determined time period due to death of the depositor or unclear forwarding address, regardless of the amount of deposit still left in the account. Closed accounts are accounts closed at the old bank. Here, although the description is based on a single old bank account data control device 211, a different old bank account data control device can be provided for each of a number of old banks that are to be merged.

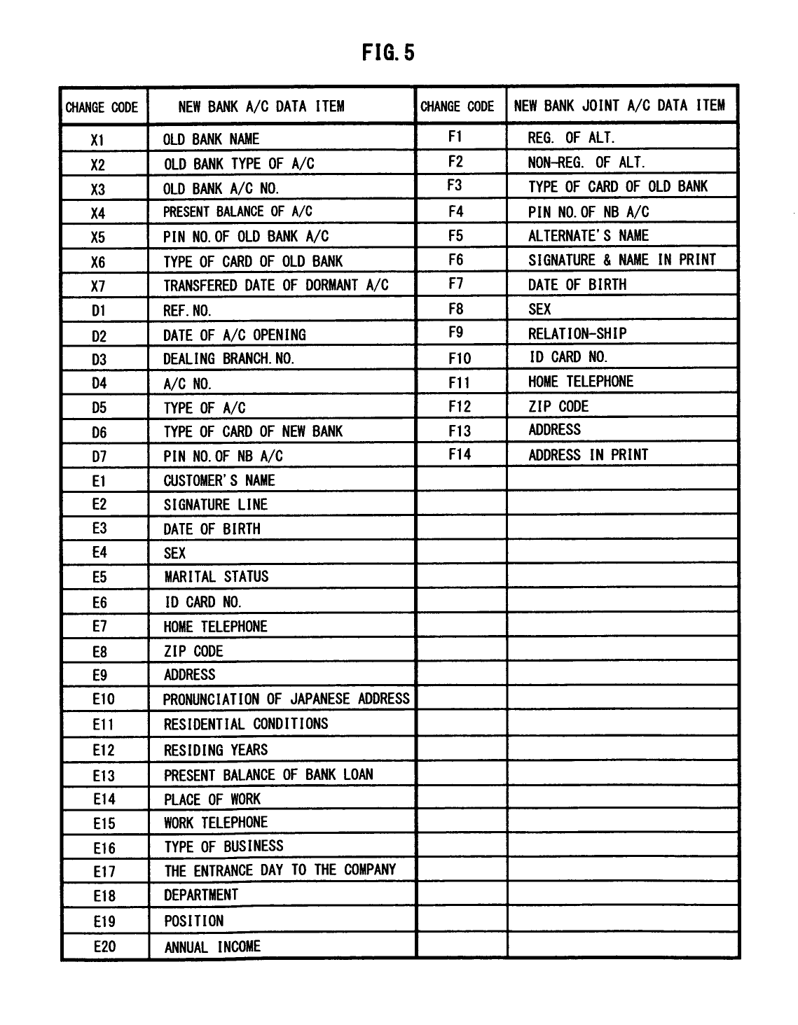

Reverting back to FIG. 2, the old bank account data conversion device 212 is a computer device for reading out the old bank account information that is input, stored and controlled in the old bank account data control device 211 and attaching a code determined for each item that is included in the read out old bank account information. A storage device 212-1 provided in the old bank account data conversion device 212 inputs, stores and controls item names for a variety of information that is included in the account information corresponding to the account information of customer accounts established at the new bank, and previously input corresponding code information that corresponds to a variety of codes that classify the item names. FIG. 5 is a figure showing an example of data for the corresponding code information that is input, stored and controlled in the old bank account data conversion device 212. Included in the corresponding code information, is change code information such as Old Bank Name, Type of Account that is information regarding the bank accounts of the old bank (Codes X1-X7), Dealing Branch Number, New Account Number, that is information regarding the bank accounts at the new bank (Codes D1-D5), information regarding customer attributes (Codes E1-E20), information regarding a customer alternate (Codes F1-F14), etc.

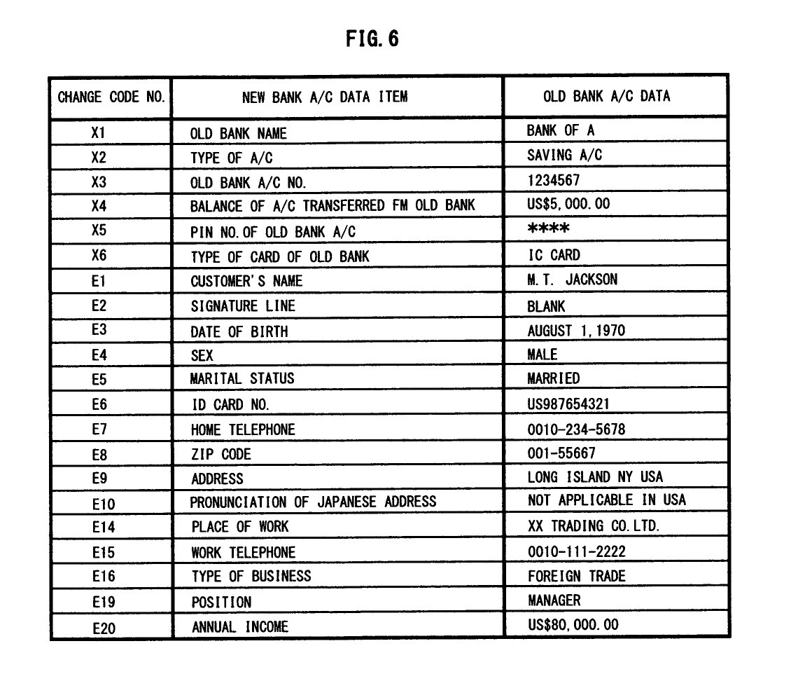

The old account data conversion device 212 also reads out, from the corresponding code information input, stored and controlled in the storage device 212-1, the codes corresponding to the item names that conform to the item names included in the account information of the old bank, and creates coded account information that constitutes each item included in the bank account information of the old bank with the read out codes attached thereto. For example, FIG. 6 shows an example of coded account information created by the old account data conversion device 212. At this point in time, the codes for information regarding the bank accounts of the old bank (Codes X1-X6), information regarding customer attributes (Codes E1-E20), etc. are attached. Here, it is thought that the plurality of customer account information sent from the same old bank is information that includes the same items in the same sequence. In this respect, by previously inputting and storing the sequence of the codes attached to the account information of the same old bank in the storage device 212-1 provided in the old bank account data conversion device 212, the process for attaching codes can be sped up and made more efficient by attaching the codes for the account information of the same old bank in the same sequence as stored.

Also, when the account information to be output from an old bank data processing center 100-1 is information that is printed material, the old bank account data conversion device 212 can create image data by scanning the printed account information, character data can be obtained from the image data by OCR processing, to create account information of the old bank using the digital data. In this way, even if the account information of the old bank is printed material, the account information can be converted to digital data.

Reverting back to FIG. 2, a new bank account data creation device 213 can create temporarily incomplete account information corresponding the variety of information included in the account information of the old bank to each item name included in the account information of the new bank based on the corresponding code information input, stored and controlled by the old bank account data conversion device 212 and the coded account information created in the old bank account data conversion device 212. Here, the new bank account data creation device 213, based on the items included in the corresponding code information input, stored and controlled by the old bank account data conversion device 212, creates an input format for writing in data for the account information of the new bank.

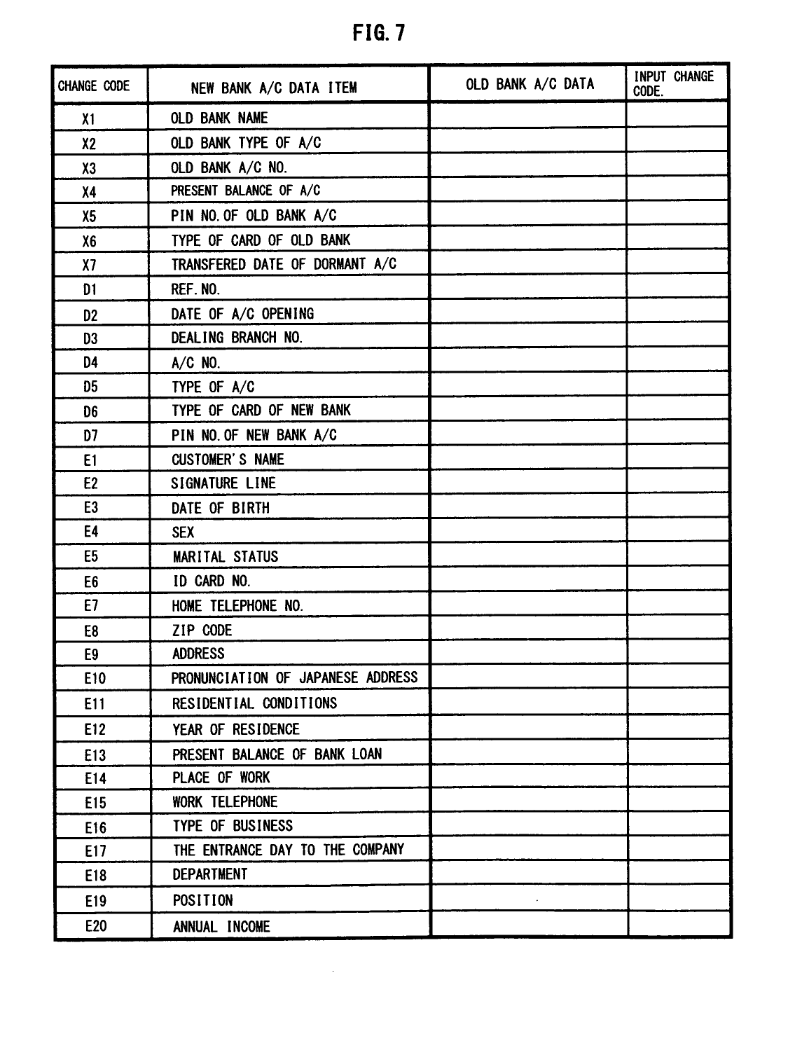

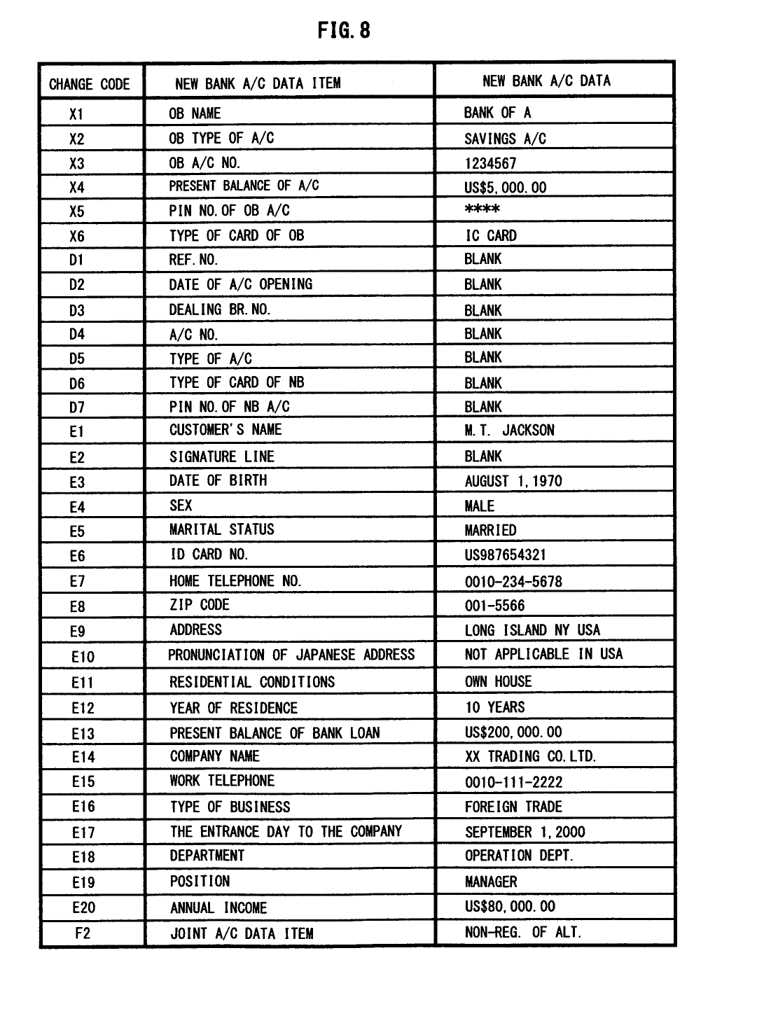

In FIG. 7, an example of data in an account information input format for the new bank created by the new bank account data creation device 213 is shown. The initial state of the account information input format created by the new bank account data creation device 213 is with the old bank customer data empty. The new bank account data creation device 213, for each item included in the coded account information created by the old bank account data conversion device 212, inputs information corresponding to the items that agree with the codes included in the input format. FIG. 8 shows an example of data of a filled in input format in which information based on the codes included in the coded account information is input. As seen in the figure, information (Codes X1-X6, Codes D1, D3/X2-D5, Codes E1-E20, Code F2, etc.) included in the account information of the old bank is input into the input format by the new bank account data creation device 213.

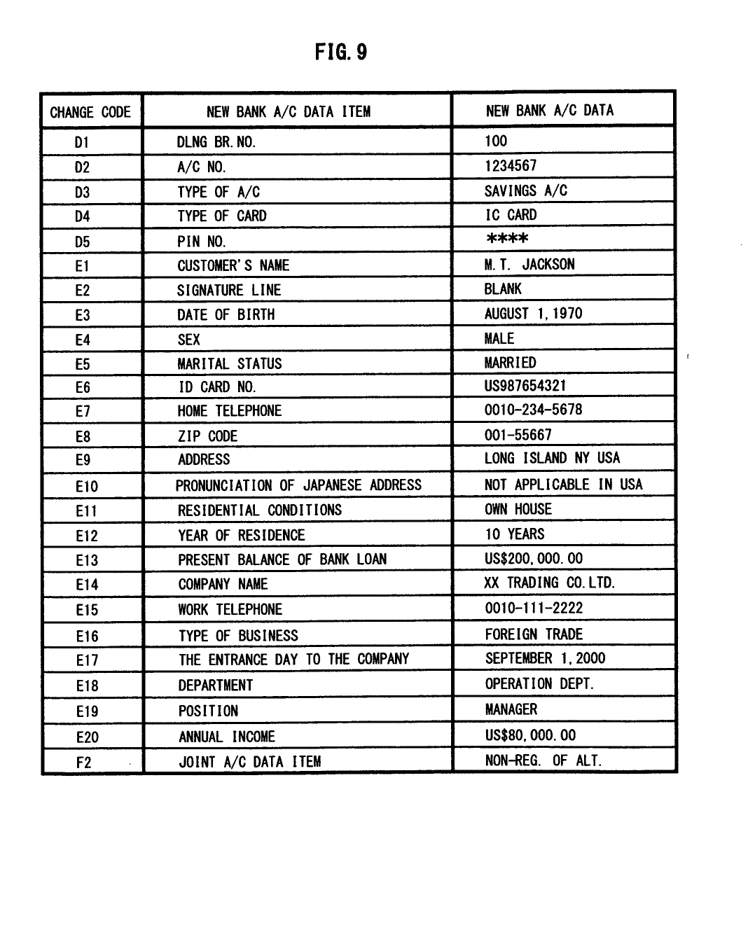

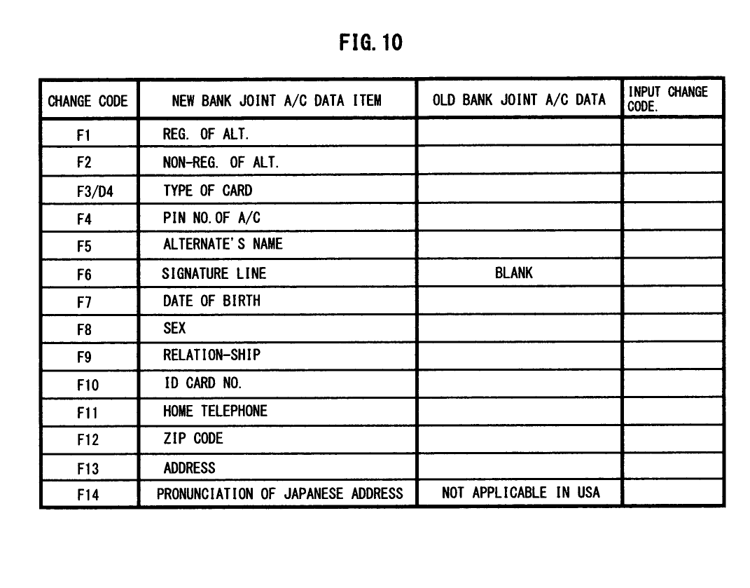

Here, in the new bank account data creation device 213, regular savings account which is the same as in the old bank is automatically entered and shown as the new bank account type in the type of bank account item D3/X2 in FIG. 8. At this time, the information regarding the new bank such as the Dealing Branch Number (D1-D5 excluding D3/X2) and the information sought as the new bank account information that is not included in the old bank account information (Codes E11-E13, etc.) are blank. The new bank account data creation device 213 inputs, stores and controls the newly created temporarily incomplete account information of the new bank in a temporary control device for un-transferrable incomplete new bank account data 222. The temporarily incomplete account information of the new bank is output to the temporary control device for un-transferrable incomplete new bank account data 222 until an application to input account information is completed by the filing of account information in response to the operation of a device for setting up a new bank account 301 that is provided at the head office or branch 300 of the new bank by a customer. FIG. 9 shows an example of data created for the account information of the new bank. Further, the new bank account data creation device 213 can record an alternate or joint account holder information along with the customer information at the new bank based on the customer alternate information at the old bank. FIG. 10 is an example of data of the alternate data input format.

Reverting to FIG. 3, the construction of the new bank account data integration control device 220 will be explained in detail. The new bank account data integration control device 220 is a group of computer devices for controlling or managing the account information, etc. of the new bank (Bank AB) after a merger of a number of old banks (Bank A and Bank B). The new bank account data integration control device 220 is provided with a new bank account data control device 221, an un-transferrable incomplete new bank account data temporary control device 222 and an old bank dormant and closed bank account data controlling device 223.

The new bank account data control device 221 is a computer device for inputting, storing and controlling account information of bank accounts opened at the new bank. The new bank account data control device 221 is provided with storage devices for inputting, storing and controlling the account information in each of 5 files, i.e. an unused account number file 221-1, a drawn unused account number temporary input file 221-2, an active account data file 221-3, a dormant account data file 221-4, a closed account data file 221-5, etc.

In the unused account number file, the account numbers that can be attached to bank accounts opened at the new bank are input, stored and controlled. The drawn unused account number temporary input file is a file for temporarily inputting and recording the date and time an unused account number is drawn, the name of the branch, etc., when an unused account number is drawn from the unused account number file in response to a draw account number signal issued from a device for setting up a new bank account 301 of a branch when a customer carries out the opening of a new bank account in accordance with the input screen of a computer terminal 330 at a branch of the new bank. When the procedure for opening a new bank account is finished by completing the account data through the input of the additional customer information required by the new bank as a result of drawing out the customers information from the un-transferrable incomplete new bank account data temporary control device 222 at a branch terminal 330 in order for the customer to carry out the opening of a new bank account, the account number information stored at the drawn unused account number temporary input file is automatically erased at the same time that the completed customer account data is moved from the un-transferrable incomplete new bank account data temporary control device 222 to the active account data file 221-3 within the new bank account data control device 221.

In the active account data file, the account information of activities such as normal withdrawals and deposits from among the account information of the new bank is input, stored and controlled. In the dormant account data file, the account information of accounts that do not have transactions such as deposits and withdrawals carried out for long periods of time greater than a determined time period due to death of the depositor or unclear forwarding address, regardless of the amount of deposit still left in the account is input, stored and controlled. In the closed account data file, the closed account information from among the new bank account information is also input, stored and controlled.

The un-transferrable incomplete new bank account data temporary control device 222 is provided with un-transferrable incomplete new bank active account data temporary input file 222-1 and a drawn un-transferrable incomplete new bank active account data temporary input file 222-2 as internal devices. This un-transferrable incomplete new bank active account data temporary input file 222-1 is a file that temporarily inputs and controls incomplete account information that is created by converting old bank active account data into new bank active account data until a customer completes the process for a new bank account conversion and a new account opening. Also, the drawn un-transferrable incomplete new bank active account data temporary input file 222-2 is a file that temporarily stores the time of withdrawal, bank branch, customer name, etc. when a customer, at a branch of the new bank 300, who is proceeding with a new bank account conversion and the setting up of a new account, inserts an old bank cash card into a card reader writer 320 and draws out his own incomplete account information from the un-transferrable incomplete new bank active account data temporary input file 222-1.

Temporary incomplete account information of the new bank created by the new bank account data creation device 213 is input, stored and controlled in the un-transferrable incomplete new bank active account data temporary input file. The temporary incomplete account information of the new bank is input, stored and controlled in the un-transferrable incomplete new bank active account data temporary input file until a customer comes to a new bank branch 300 and completes the process for establishing a new bank account. When the customer carries out the above step at a computer terminal 330 at the new bank branch 300 to draw his own temporary incomplete account information from the un-transferrable incomplete new bank active account data temporary input file 222-1 above by using his old bank cash or ATM card, the time and date, branch name, customer name, etc. are stored in the drawn un-transferrable incomplete new bank active account data temporary input file 222-2.

At the same time that the customer completes his account information by inputting additional information required by his own temporary incomplete account information drawn out at the computer terminal 330 using the bank account application and the data input form described below, this drawn temporary incomplete account information is transferred as completed account information from the un-transferrable incomplete new bank account data temporary control device 222 above to the active account data control file inside the new bank account data control device 221 and at the same time that this drawn temporary incomplete account information is erased in the un-transferrable incomplete new bank account data temporary control device 222.

If this drawn temporary incomplete account information remains in the drawn un-transferrable incomplete new bank active account data temporary input file 222-2 even after a set period of time, such as over 30 minutes, has passed since the customer has drawn temporary incomplete account information from the un-transferrable incomplete new bank active account data temporary input file 222-1, a tracer signal reminding about the account set up process is sent from an non-received account data tracer signal issue unit 231 inside the communication device 230 to the computer terminal 330. Here, a new bank account corresponding to all of the temporary incomplete account information input stored and controlled in the un-transferrable incomplete new bank active account data temporary input file 222-1 within the un-transferrable incomplete new bank account data temporary control device 222 is set up, and when the process of consolidating or integrating the old bank account data is completed, the un-transferrable incomplete new bank account data temporary control device 222 may be removed from the new bank account data integration control device 220 as unneeded equipment.

Reverting back to FIG. 1, the old bank dormant and closed bank account data controlling device 223 is a computer device for inputting, storing and controlling account data of the old bank. As the old bank dormant account data is in a state where the account holder cannot be contacted, it is input and stored in the old bank dormant and closed bank account data controlling device 223 as is without being converted to new bank account data and maintained for a set period of time, but if there is some sort of contact or inquiry from the account holder, the new bank can recommend the procedure for setting up an account at the new bank. On the other hand, old bank closed bank data can be handled as an account that cannot be reopened and maintained as the old bank closed bank account data in the old bank closed bank account file for a set period of time.

The communication device 230 is a device for transmitting and receiving information with a computer device connected by a network and is provided with an interface unit 230-1, a processing unit 230-2 and an non-received account data tracer signal issue unit 230-3. First, the interface unit 230-1 is a communication device for carrying out the exchange of account information between the data processing centers of the old banks that are to merge, the branches of the new bank, etc. The processing unit 230-2 is a device that reads out the account information received through the interface unit 230-1, the data input and output from the old bank account data control conversion creation device 210 and the new bank account data integration control device 220, to control and process the input and output from each of the respective devices.

The non-received account data tracer signal issue unit 230-3 is a device for issuing a tracer signal to a computer terminal at a branch of the new bank 300 if a customer at the branch 300 draws an unused account number from the new bank data control device 221 or drawn temporary incomplete account information remains in the drawn un-transferrable incomplete new bank active account data temporary control device 222 even after a set period of time, such as over 30 minutes, has passed since the customer has drawn temporary incomplete account information, reminding about the account set up process.

A branch of the new bank 300 is a branch where a customer of the old bank can set up a new bank account. At this branch, devices such as a communication device 310, a card reader writer 320, computer device 330, a device for issuing agreements to convert to a new bank account, account applications, new passbooks, cards such as ATM cards 340, etc. are provided as a device for setting up a new bank account 301. First, the communication device 310 is provided with an interface unit 310-1 for exchanging account information with the data processing center 200 of the new bank, a processing unit 310-2 for reading out account data that is input from the above interface unit and precisely reading out account data from the above card reader writer 320 and computer terminal 330, to control and process the input and output from each of the respective devices, and a device for issuing a signal to automatically draw an account number 310-3 as a device for drawing an unused account number from the new bank account data control device 221 of the data processing center 200 of the new bank when a customer applies to set up an account.

Also, a card reader writer 320 is provided so that when a customer is setting up an account at the new bank, he can use his old bank cash or ATM card to draw his own temporary incomplete account information from the un-transferrable incomplete new bank active account data temporary control device 222 of the new bank data processing center 200. Moreover, the computer terminal 330 is provided with new bank account application data input file that stores a new bank account application data input file for completing the account data of a customer, a new bank account conversion agreement and account application form file 330-2 that stores new bank account conversion agreements and account application forms, etc.

Further, there is provided a device for immediately printing issuing agreements to convert to a new bank account, account applications, new passbooks, and cards such as ATM cards 340 when the customer completes the process for setting up a new account. The customer, with the help of the above devices at a branch of the new bank 300, can complete the set up of an account at the new bank on the spot, and further, the branch of the new bank can also execute the business of processing the set up of a new account in an efficient and timely fashion.

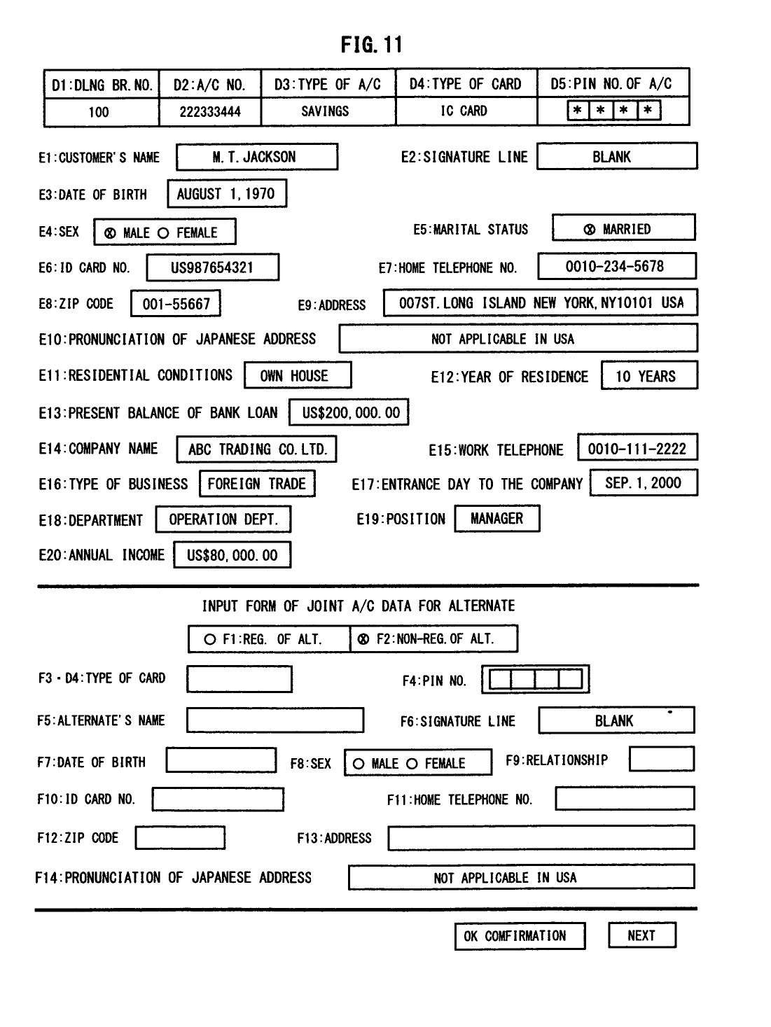

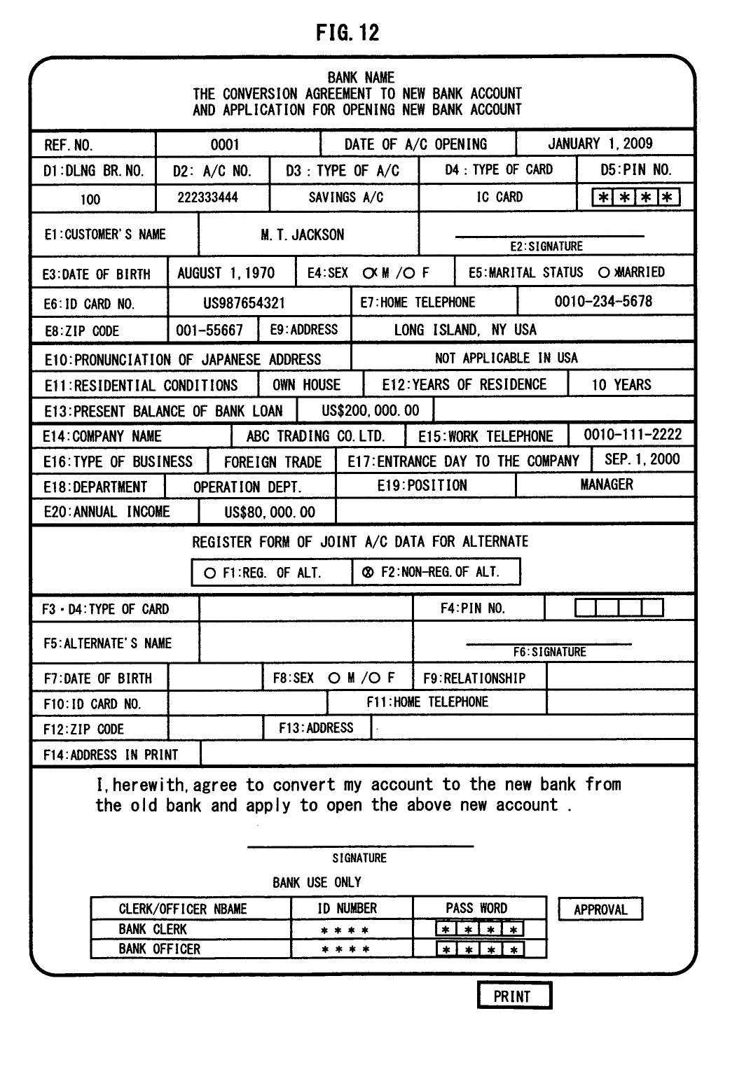

In FIG. 11 is shown an example of an account information input screen that is displayed on computer terminal 330. The computer terminal 330 receives such input as the information regarding the bank accounts at the new bank (Codes D1-D5), information regarding customer attributes (Codes E1-E20). Here, the dealing branch number (Code D1) is automatically input by the computer terminal 330. Also, the account number (Code D2) is input with the account number drawn from the unused account numbers input, stored and controlled in the new bank account data integration control device 220 by the device for issuing a signal to automatically draw an account number 310-3 in the communication device 310, when the input screen is displayed. In the input screen, when the submit application button represented by the Code a is pressed, a confirmation screen for confirming the input information is displayed by the terminal 330. FIG. 12 is a diagram of an example of a confirmation screen displayed on computer terminal 330. In the confirmation screen, when the print button represented by the Code a is pressed, the application form describing the account information displayed on the confirmation screen is printed out by the device 340 for issuing ATM cards, etc. The device 340 for issuing ATM cards, etc., is a computer device for issuing account applications, new passbooks, etc.

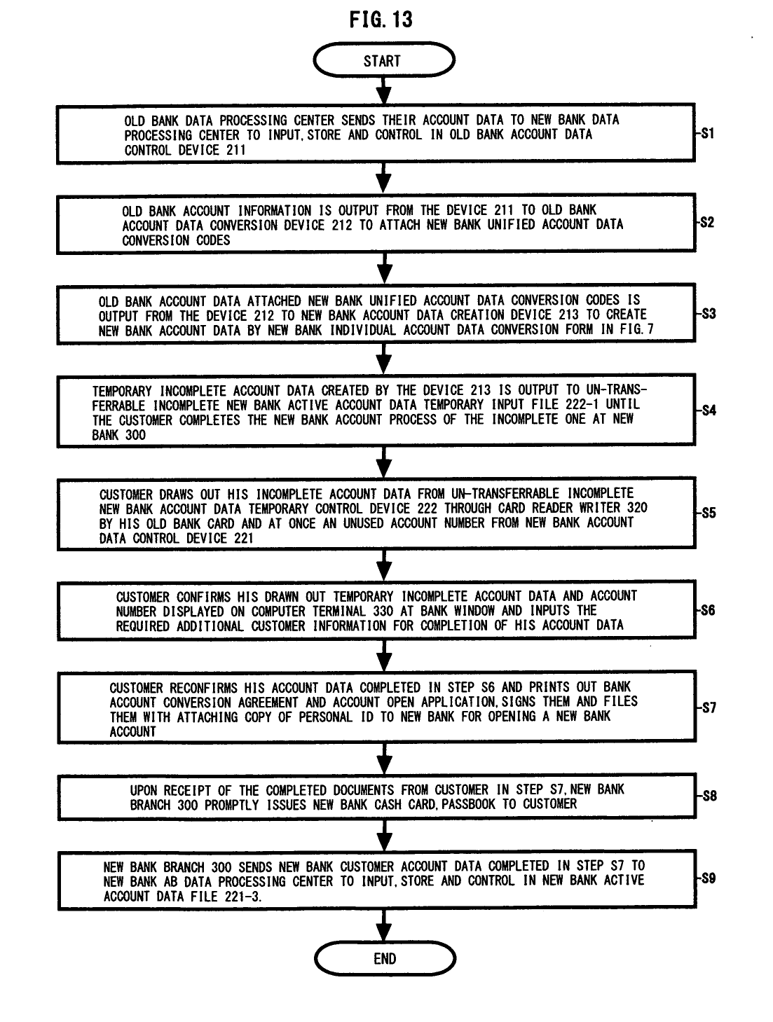

Next, an example of the operation of the present embodiment of the bank account integration control system will be described. FIG. 13 is a flow chart one example of the new bank account data conversion, creation, completion and integrating process carried out by the bank account integration control system 1 based on the account data of the old bank. First, in step S1, the old bank account information that is sent from the old bank data processing center through the interface unit 230-1 of the communication device 230 is input, stored and controlled by the old bank account data control device 211.

In step S2, the old bank account information that is input, stored and controlled by the old bank account data control device 211 in step S1, is output from the old bank account data control device 211 to the old bank account data conversion device 212 by the control processing of the processing unit 230-2, and has the new bank account conversion codes attached according to the new bank unified account data conversion code table shown in FIG. 5 and the new bank individual account data conversion form shown in FIG. 6. that are stored in the device 212. In step S3, the old bank account data that has the new bank account conversion codes attached by the old bank account data conversion unit 212 in step S2 above, is output from the old bank account data conversion device 212 to the new bank account data creation device 213 by the control processing of the processing unit 230-2 to create new bank account information according to the new bank individual account data conversion form shown in FIG. 7.

In step S4, the temporary incomplete account information created in the new bank account data creation device 213 in step S3 above, is temporarily input and stored in the un-transferrable incomplete new bank active account data temporary input file 222-1 in the un-transferrable incomplete new bank account data temporary control device 222 by the control processing of the processing unit 230-2, until the customer completes the new bank account conversion process and the set up process.

In step S5, the customer inserts his old bank cash or ATM card into the card reader writer 320 provided in the device for setting up a new bank account 301 at the new bank branch 300, and draws out on the computer terminal 330, his own temporary incomplete account information from the un-transferrable incomplete new bank account data temporary control device 222 of the new bank data processing center 200 through the communication device 310 and at the same time an unused account number from the new bank account data control device 221.

In Step S6, the customer confirms that his own temporary incomplete account information and account number drawn out in Step S5 are displayed in the account information input column and account number input column of the respective application to open a bank account and data input form of FIG. 11 that are displayed on the above computer terminal 330 and further inputs the required additional customer information to complete the account information for that customer.

In Step S7, the customer reconfirms that the customer account information that is input in the bank account conversion agreement and application to open an account FIG. 12 that are displayed on computer terminal 330, is the customer's own new bank account information completed in Step S6 above, and has both the bank account conversion agreement and application to open an account printed out, signs them, and attaches a copy of some personal identification to complete the process for opening an account at the new bank. The new bank branch 300, at Step S8, then promptly issues a cash or ATM card and a passbook for the new bank to the customer and at the same time receives cash or ATM cards of the old bank from the customer and destroys them.

The new bank branch 300 sends the new bank customer account information completed in steps S7 and S8 above to the data processing center 200 of the new bank via the communication device 310. The new bank data processing center 200 inputs, stores and controls the received new bank customer account information above as new bank active account data in the active account data file 221-3 within the new bank account data control device 221 under the controlled processing of the processing unit 230-2.

Also, at the same time in Step S9, the relevant temporary incomplete account information temporarily stored in the drawn un-transferrable incomplete new bank active account data temporary input file 222-2 within the un-transferrable incomplete new bank account data temporary control device 222 and the relevant drawn unused account number input and stored in the drawn unused account number temporary input file 221-2 within the new bank account data control device 221 are respectively deleted automatically. The above constitutes the new bank account information work flow.

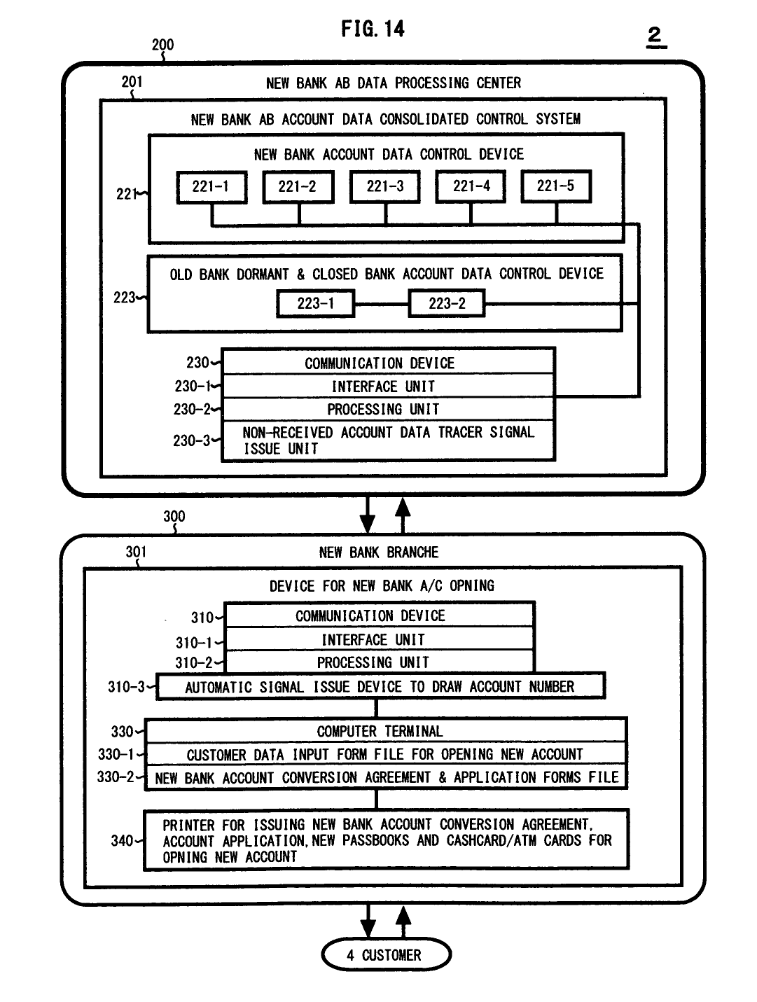

Further, according to this embodiment, when all the new bank account conversion processing is completed by creating all the account information for the new bank, all of the devices within the old bank account data control conversion creation device 210 as well as all the un-transferrable incomplete new bank account data temporary control device 222 within the new bank account data consolidation control device can be removed as unneeded devices. As a result, the remaining devices such as the un-transferrable incomplete new bank active account data temporary input file 222-1, the old bank dormant and closed bank account data controlling device 223, the communication device 230, etc. within new bank AB account data consolidated control system 201 can continue to be used as devices comprising the new bank AB account data consolidated control system of the new bank data processing center 200 as shown in FIG. 14.

Also, even though the present embodiment was explained in relation to an example where the old bank account data related to the merger consolidation process was consolidated by two main devices and a plurality of other devices in the new bank data processing center 200, when a merger consolidation among more than two banks is carried out, old bank account data control conversion creation devices 210 as well as un-transferrable incomplete new bank account data temporary control devices 222 having the same functions may be provided at each merging bank in order to carry out the business of processing in an efficient and timely fashion.

Also, even though the present embodiment was explained in relation to an example where the consolidation processing was carried out by a plurality of computer groups provided in the new bank data processing center 200, a single computer having the functions of each computer set up on the old bank account data control conversion creation device 210 or the new bank account data integration control device 220 discussed above may also provided. In this case, a bank consolidation control system may also be constituted by being provided with corresponding code information storage unit for previously inputting, storing and controlling corresponding codes (corresponding to old bank account data conversion device 212), an old bank account information storage unit for inputting, storing and controlling old bank account information (corresponding to old bank account data control device 211), an old bank account information recordal unit for inputting, storing and controlling account information of the old bank in the old bank account information recordal unit (corresponding to communication device 230), a unit for creating coded account information for creating coded information by attaching code to account information of the old bank (corresponding to old bank account data conversion device 212) and a new bank account information creation unit for creating account information of the new bank based on the corresponding code information and the coded account information (corresponding to new bank account data creation device 213), etc. Further, each of the computer devices shown in the figures of the present embodiment may also carry out parallel processing by providing a number of computers having the same functions, in order to carry out the conversion process even faster and more efficiently by dispersing the processing load.

As explained above, according to this embodiment, when a specific bank merges with another bank it becomes possible to quickly, efficiently and further, reliably create account information for the new bank after the merger based on the customer account information at the old bank. In this way, business such as the consolidation processing of huge amounts of customer account information that is generated along with a corporate name change, issuing a large amount of passbooks and bank cards such as cash or ATM cards, etc., that arise from such events as the merger or reorganization of large banks, bank nationalizations, arising due to recent financial crises, can be executed appropriately, in a short period of time and further efficiently.

Also, as the data processing center 200 of the new bank can carry out the batch conversion processing of account data corresponding to several banks, it becomes possible to convert the account information with each old bank data control device of the old bank only outputting the account information without having to carryout processing such as attaching codes, etc. Further, the process for opening an account can be completed by having the customer actually come to a new bank branch 300, input the account information and sign the respective forms, the input work by bank employees, etc. of the new bank, can be reduced and the identity of the person opening the account can be reliably confirmed.

Further, the computer program for realizing the functions of the processing units of the present invention can be stored on a computer readable storage medium, then read from the storage medium onto a computer system, by which the consolidation control can be carried out promptly. Also, the computer system mentioned here contains an OS and hardware such as peripheral equipment. Further, the computer system also contains a World Wide Web or WWW system with a home page providing or displaying environment. Additionally, the computer readable storage medium refers to removable mediums such as flexible disks, optical disks, ROM, CD-ROM's, etc. or hard disks, etc., installed in the computer system. Further, computer readable storage medium also includes volatile memory such as RAM memory that are in a computer system that can serve as a server or a client when the program is sent ever telecommunication lines such as telephone lines or networks such as the internet to temporarily store the program.

Also, the above program may also be forwarded to another computer system from the computer system storing the program in a storage device, etc., by a transmitting medium or by a transmission waves in the transmitting medium. Here, the transmitting medium that transmits the program refers to a medium that has the capability to transmit information such as a network such as the Internet, lines of communication such as a telephone network, etc. Also, the above program may be for executing only a portion of the functions mentioned above. Further, the above functions may also be executed by mixing them with a program already installed in the computer system, a so-called grafted file.

What I claim is:

1. A bank account integration control system characterized in comprising:
a corresponding code information storage unit into which is previously input and stored corresponding code information that corresponds to item names of a plurality of information that includes second account information corresponding to customer bank accounts established at a second bank which is a bank remaining after a merger of a first bank and another bank and a plurality of code that identifies the item names are,
an old bank account information storage unit that stores a plurality of information that is made to correspond to each item name that is included in first bank account information corresponding to customer bank accounts established at the first bank,
an old bank account information recordal unit that receives the first account information and stores the received first account information in the old bank account information storage unit,
a coded account information generating unit that reads out code stored in the corresponding code information storage unit that is made to correspond to the item names that are the same as the item names included in the first account information and creates coded account information that the read out code imparted to each item name that is included in the first account information, and
a new bank account information generating unit that, based on the corresponding code information and the coded account information, creates account information that corresponds the plurality of information included in the first account information with each item name included in the second account information.

2. A bank account integration control system according to claim 1 characterized in being further provided with an input unit that accepts input of information from the customers that corresponds to the item names included in the second account information,
the new bank account information generating unit creating the second account information based on the information input into the input unit.

3. A bank account integration control system according to claim 1 characterized in being further provided with an old bank dormant account information and closed account information storage unit,
the old bank account information recordal unit inputting, storing and managing this first account information in the old bank closed account information storage unit when the type of information shown by the account information included in the received first account information indicates that it is a dormant account or a closed account.
